(19) United States
(12) Patent Application Publication
(10) Pub. No.: US 2004/0109600 A1
(43) Pub. Date: Jun. 10, 2004

(54) Inspection tool with partial framing camrea

(76) Inventor: Cory Watkins, Chanhassen, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/623,283

(22) Filed: Jul. 18, 2003

Related U.S. Application Data
(60) Provisional application No. 60/397,327, filed on Jul. 18, 2002.

(51) Int. Cl. G06K 9/00

(52) U.S. Cl. 382/145

(57) ABSTRACT

An inspection system, and process for use thereof, allows for inspecting of semiconductors or like substrates with minimal or no wasted image space.

### CROSS-REFERENCE TO RELATED APPLICATION

This application claims the benefit of U.S. Provisional Patent Application No. 60/397,327, filed on Jul. 18, 2002 and entitled “Inspection Tool with Partial Framing Camera”.

### BACKGROUND OF THE INVENTION

1. Technical Field

The present invention relates to a system, and process for use thereof, for inspecting wafers and other semiconductor or microelectronic substrates.

2. BACKGROUND INFORMATION

Over the past several decades, the microelectronics and semiconductor has exponentially grown in use and popularity. Microelectronics and semiconductors have in effect revolutionized society by introducing computers, electronic advances, and generally revolutionizing many previously difficult, expensive and/or time consuming mechanical processes into simplistic and quick electronic processes. This boom has been fueled by an insatiable desire by business and individuals for computers and electronics, and more particularly, faster, more advanced computers and electronics whether it be on an assembly line, on test equipment in a lab, on the personal computer at one's desk, or in the home via electronics and toys.

The manufacturers of microelectronics and semiconductors have made vast improvements in end product quality, speed and performance as well as in manufacturing process quality, speed and performance. However, there continues to be demand for faster, more reliable and higher performing semiconductors.

One process that has evolved over the past decade plus is the microelectronic and semiconductor inspection process. The merit in inspecting microelectronics and semiconductors throughout the manufacturing process is obvious in that bad wafers may be removed at the various steps rather than processed to completion only to find out a defect exists either by end inspection or by failure during use. In the beginning, wafers and like substrates were manually inspected such as by humans using microscopes. As the process has evolved, many different systems, devices, apparatus, and methods have been developed to automate this process such as the method developed by August Technology and disclosed in U.S. Pat. No. 6,324,298 B1. Many of these automated inspection systems, devices, apparatus, and methods focus on two dimensional inspection, that is inspection of wafers or substrates that are substantially or mostly planar in nature.

Currently, CCD camera systems are used to inspect various objects. Many times, the objects are repeating patterns, such as those on a semiconductor wafer. In the case where the pattern does not perfectly match the camera field of view (FOV), there is wasted image space in either the first camera frame of the pattern, for those cases where the pattern is smaller than the FOV, or in the subsequent frames of the pattern, for those cases where the pattern is larger than a single FOV.

### SUMMARY OF THE INVENTION

The inspecting of semiconductors or like substrates with minimal or no wasted image space is accomplished by the present invention, which is an inspection device including at least a camera with the ability to selectively readout a number of rows, and further comprising a controller that programs the camera to readout a specified number of rows.

### BRIEF DESCRIPTION OF THE DRAWINGS

Preferred embodiment of the invention, illustrative of the best mode in which applicant has contemplated applying the principles, are set forth in the following description and are shown in the drawings and are particularly and distinctly pointed out and set forth in the appended claims.

FIG. 1 is a diagram illustrating an automated defect inspection system according to one embodiment of the present invention.

FIGS. 2 and 3 are schematics of the process of the present invention.

Similar numerals refer to similar parts throughout the drawings.

### DETAILED DESCRIPTION OF THE PREFERRED EMBODIMENT

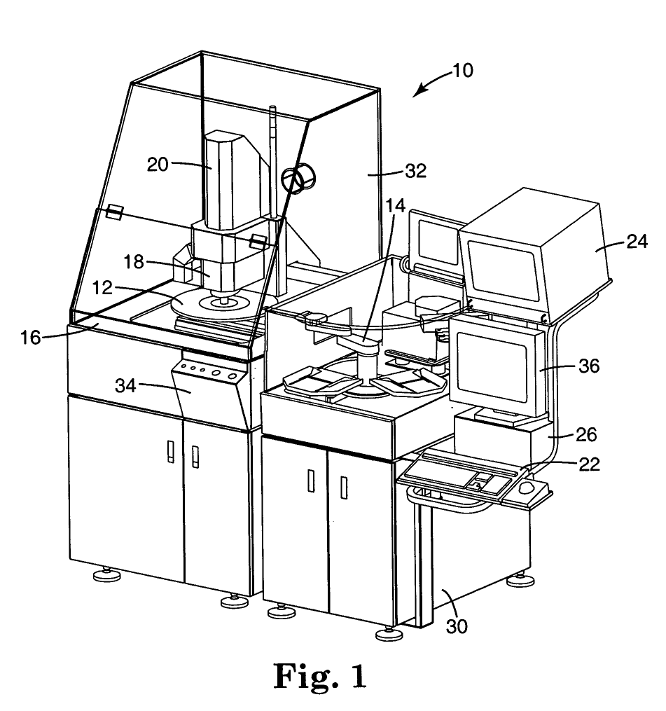

FIG. 1 is a diagram illustrating an automated defect inspection system 10 according to one embodiment of the present invention. System 10 is used in one environment to find defects on die on patterned wafers W, but is intended for this and other uses including for inspecting whole wafers, sawn wafers, broken wafers, wafers of any kind on film frames, die in gel paks, die in waffle paks, MCMs, JEDEC trays, Auer boats, and other wafer and die package configurations (although hereinafter all of these uses shall be referred to generally as inspection of wafers W). The basic operation of system 10 according to one embodiment is described in detail in commonly-assigned U.S. Pat. No. 6,324,298, and is summarized below with reference to FIG. 1.

System 10 includes a wafer test plate 12, means for providing a wafer to the test plate referred to as 14, a wafer alignment device 16 for aligning each and every wafer at the same x, y, and θ location or x, y, z, and θ location, a focusing mechanism 18, a camera 20 or other visual inspection device for visual inputting of good die during training and for visual inspection of other unknown quality die during inspection, a parameter input device 22 for inputting parameters and other constraints or information such as sensitivity parameters, geometries, die size, die shape, die pitch, number of rows, number of columns, etc., a display 24 for displaying the view being seen by the camera presently or at any previously saved period, a computer system 26 or other computer-like device having processing and memory capabilities for saving the inputted good die, developing a model therefrom, and comparing or analyzing other die in comparison to the model, a frame 30, a hood 32, a control panel 34, and a system parameters display 36.

The means for providing a wafer to the test plate referred to as 14 may be either manual in that the user moves the wafer from a cassette or magazine to the test plate 12, or automatic as is shown in the embodiment of FIG. 1. In the automatic environment, the wafer providing means 14 includes a robotic arm that pivots from a first position where a wafer W is initially grasped from a magazine or cassette to a second position where the wafer W is positioned on the wafer test plate 12 for inspection. After inspection, the robotic arm pivots the wafer W from the second position at the test plate 12 back to the first position where the wafer W is placed back in or on the magazine or cassette.

In one form of the invention, system 10 is trained as to what a “good die” comprises by aligning via device 16 and viewing via camera 20 a plurality of known good die and forming a model within computer system 26 to define what an ideal die should look like based upon the common characteristics viewed. In one embodiment, after being trained, system 10 is used to inspect die of unknown quality. During inspection according to one embodiment, system 10 collects an image of a wafer W using the camera 20 by moving the plate 12 to align the camera with a first die or other portion thereof, viewing and recording that die or portion thereof by opening the shutter and allowing the camera to view and record the image, moving the plate 12 to align the camera with a second die or portion thereof, viewing and recording the second die or portion thereof, and repeating these steps until all of the die or portions thereof on the wafer that are desired to be viewed have been viewed and recorded. In one embodiment, system 10 determines where defects are located on a given die being viewed based upon the “good die” model.

In another embodiment, rather than using a stop and go procedure to capture images of die on the wafer W, system 10 collects an image of the wafer W using the camera 20 by continuously moving the plate 12 so as to scan over all of the die on the wafer, whereby the wafer is illuminated by a strobe light at a sequence correlating to the speed of the moving plate so that each die is strobed at the precise time it is under the camera 20. This allows for the continuous collecting of images without necessitating the stop and go procedure of aligning the camera with a first die, viewing and recording that die, moving the plate 12 to align the camera with a second die, viewing and recording this second die, and repeating these steps until all of the die on the wafer have been viewed and recorded, etc.

The inspection system of the present invention inspects semiconductors or like substrates with minimal or no wasted image space. The system specifically uses the principal of partial framing, the selective process of reading out a particular number of imager rows and dumping the charge on the remaining un-important rows to solve the problem of wasted image space in either the first camera frame of the pattern, for those cases where the pattern is smaller than the field of view (FOV), or in the subsequent frames of the pattern, for those cases where the pattern is larger than a single FOV.

In one embodiment, camera 20 (FIG. 1) allows for a mode of operation called partial framing. If the camera 20 has 1024 columns×1024 rows of pixels, and the camera 20 is set to partial frame using just the first 256 rows, the camera 20 will expose the entire imager, readout the first 256 rows, and then rapidly dump charge on the imager to get ready for the next exposure. Thus, the camera 20 selectively reads out groups of pixels in one axis of the imager. Variations of this process all achieve the same result; reducing the number of pixel rows readout nearly linearly increases the camera frame rate. This is important for scanning inspection systems. A higher frame rate allows the scanner to operate faster in the scan axis than if you were not to partial frame.

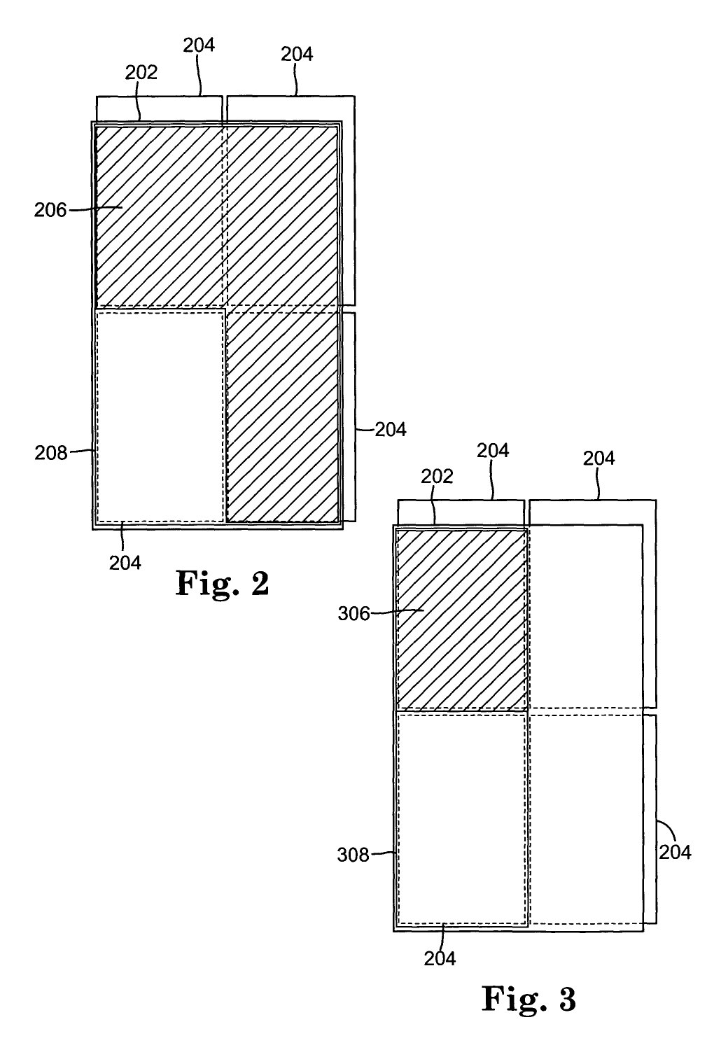

FIGS. 2 and 3 illustrate this point. FIG. 2 is a schematic diagram illustrating a 2×2 array of four die 204, and a full frame FOV 202 of camera 20. The sum of the die size and the alignment border is greater than one half of the FOV 202. Acquired frame 208 represents image data read out of the imager by camera 20. In the embodiment illustrated in FIG. 2, partial framing is not used, and acquired frame 208 includes image data corresponding to the entire FOV 202. Acquired frame 208 includes image data representing the entire lower left die 204 (i.e., the un-shaded portion of frame 208) as well as image data representing substantial portions of the other three die 204 (i.e., the shaded portion of frame 208). The shaded portion of acquired frame 208 is referred to as wasted image data 206. In the illustrated embodiment, approximately seventy-five percent of the acquired frame 208 is wasted image data 206. If camera 20 is running at thirty frames per second, this translates to imaging thirty die 204 per second.

FIG. 3 is a schematic diagram illustrating a 2×2 array of four die 204, a full frame FOV 202 of camera 20, and an acquired frame 308 based on partial framing according to one embodiment of the present invention. The sum of the die size and the alignment border is greater than one half of the FOV 202. Acquired frame 308 represents image data read out of the imager by camera 20. In the embodiment illustrated in FIG. 3, partial framing is used, and the number of image rows read out of the imager by camera 20 for each frame is set to a value corresponding to the sum of the die size and the alignment border. Acquired frame 308 includes image data representing the entire lower left die 204 (i.e., the un-shaded portion of frame 308) as well as image data representing a substantial portion of the upper left die 204 (i.e., the shaded portion of frame 308). The shaded portion of acquired frame 308 is referred to as wasted image data 306. By reducing the number of rows read out of the imager by camera 20 for each frame, the amount of wasted image data is reduced, and the frame rate of camera 20 can be increased to about sixty frames per second, which translates to imaging about sixty die 204 per second.

Please note, FIGS. 2 and 3 illustrate a representative case for what the die layout and camera full frame field-of-view is. Other layouts including the die being much larger than the camera full FOV apply. In that case, the acquired frame would be set to the lowest integer number of frames possible to capture the entire die.

Accordingly, the invention as described above and understood by one of skill in the art is simplified, provides an effective, safe, inexpensive, and efficient device, system and process which achieves all the enumerated objectives, provides for eliminating difficulties encountered with prior devices, systems and processes, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

Having now described the features, discoveries and principles of the invention, the manner in which it is constructed and used, the characteristics of the construction, and the advantageous, new and useful results obtained; the new and useful structures, devices, elements, arrangements, parts and combinations, are set forth in the appended claims.

What is claimed is:

1. An inspection system including at least a camera with the ability to selectively readout a number of rows.

2. The inspection system of claim 1, further comprising a controller that programs the camera to readout a specified number of rows.

3. The inspection system of claim 2, wherein the camera includes an imager having a first number of rows, and wherein the specified number of rows is less than the first number of rows.

4. The inspection system of claim 2, wherein the inspection system is configured to inspect semiconductor substrates.

5. The inspection system of claim 4, wherein the semiconductor substrates comprise a plurality of semiconductor die, and wherein the controller is configured to program the camera to readout the specified number of rows based on a size of the semiconductor die or pattern.

6. The inspection system of claim 5, wherein the size of the semiconductor die or pattern is less than a field of view of the camera.

7. The inspection system of claim 5, wherein the size of the semiconductor die or pattern is greater than a field of view of the camera.

8. An inspection device including at least a camera with the ability to selectively readout groups of pixels in one axis of an imager of the camera.

9. The inspection device of claim 8, further comprising a controller that programs the camera.

10. The inspection device of claim 9, wherein the controller programs the camera to readout a specified number of groups of pixels in one axis of the imager.

11. The inspection device of claim 10, wherein the imager has a first number of rows, each of the groups of pixels is a row of pixels, and the specified number of groups of pixels is less than the first number of rows.

12. The inspection device of claim 10, wherein the inspection device is configured to inspect semiconductor substrates.

13. The inspection device of claim 12, wherein the semiconductor substrates comprise a plurality of semiconductor die, and wherein the controller is configured to program the camera to readout the specified number of groups of pixels based on a size of the semiconductor die or pattern.

14. The inspection device of claim 13, wherein the size of the semiconductor die or pattern is less than a field of view of the camera.

15. The inspection device of claim 13, wherein the size of the semiconductor die or pattern is greater than a field of view of the camera.

16. An automated method of inspecting a plurality of semiconductor die, the method comprising:
providing a camera including an imager;
capturing image frames of the plurality of semiconductor die with the imager, each captured frame including a first number of rows of pixels;
reading out pixel data from the imager for each captured frame, the pixel data for each captured frame including a second number of rows of pixels that is less than the first number of rows of pixels; and
identifying defects in the plurality of semiconductor die based on the pixel data read out from the imager.

17. The method of claim 16, and further comprising:
programming the camera to read out the second number of rows of pixels based on a size of the semiconductor die or pattern.

18. The method of claim 16, wherein a size of each of the semiconductor die or pattern is less than a field of view of the camera.

19. The method of claim 16, wherein a size of each of the semiconductor die or pattern is greater than a field of view of the camera.
